(19) United States
(12) Patent Application Publication
(10) Pub. No.: US 2016/0335066 A1
(43) Pub. Date: Nov. 17, 2016

(54) SYSTEM AND METHOD FOR AUTOMATICALLY DEPLOYING CLOUD

(71) Applicant: SAMSUNG ELECTRONICS CO., LTD., Suwon-si (KR)

(72) Inventors: Yanzi ZHANG, Xi'an City (CN); Tao ZHANG, Xi'an City (CN); Gang LI, Xi'an City (CN); Liyuan ZHANG, Xi'an City (CN); Wei ZHAO, Xi'an City (CN)

(21) Appl. No.: 15/064,948

(22) Filed: Mar. 9, 2016

(30) Foreign Application Priority Data
May 13, 2015 (CN) 201510243267.8

(51) Int. Cl. G06F 9/445

(52) U.S. Cl. CPC G06F 8/61

(57) ABSTRACT

A system for automatically deploying a cloud includes an interface, a deployment manager, a server manager, and a deployment task executor. The interface receives cloud deployment information which includes a cloud platform type, an operating system (OS) type, at least one server at which cloud to be deployed, and a node type subordinate to the cloud platform type of the at least one server. The deployment manager determines cloud components matching the node type subordinate to the cloud platform type as cloud components to be deployed at the at least one server. The server manager pushes an OS installation file and a configuration file matching the OS type for installation at least one server. The deployment task executor deploys the determined cloud components at the at least one server.

### CROSS-REFERENCE TO RELATED APPLICATION

Chinese Patent Application No. 201510243267.8, filed on May 13, 2015, and entitled, “A System and Method for Automatically Deploying Cloud,” is incorporated by reference herein in its entirety.

### BACKGROUND

1. Field

One or more embodiments described herein relate to a system and method for automatically deploying cloud.

2. Description of the Related Art

Many types of cloud computing systems have been developed. These systems allow users to remotely access computing, storage, and network resources, thereby alleviating the need to purchase the physical resources themselves. Examples of cloud infrastructure providing platforms include OpenStack, CloudStack, and Eucalyptus. However, it is difficult to flexibly build a personal or private cloud computing platform. It is also difficult to create a personal data center using existing cloud computing platforms without being restricted by various features of the platforms and their operating systems.

### SUMMARY

In accordance with one or more embodiments, a system for automatically deploying a cloud includes an interface to receive cloud deployment information; a deployment manager to receive the cloud deployment information from the interface, the deployment information including at least one of a cloud platform type, an operating system (OS) type, at least one server at which cloud to be deployed, or a node type subordinate to the cloud platform type of the at least one server, the deployment manager to determine cloud components matching the node type subordinate to the cloud platform type as cloud components to be deployed at the at least one server; a server manager to pushes an OS installation file and a configuration file matching the determined OS type for installation at least one server; a deployment task executor to deploy the determined cloud components at the at least one server.

The server manager may determine an available server and output information indicative of the available server via the interface for selection. The system may include an authentication manager to authenticate authentication information received through the interface, wherein the interface is to receive the cloud deployment information after the authentication information is authenticated. The system may include a deployment monitor to monitor deployment of the cloud components by the deployment task executor and provides an address for logging the cloud to the user after the deploying of the cloud components.

The cloud components may include at least one of calculating service component, storage service component, network service component, authentication service component, mirror service component and data base component. The node type of the server may include at least one of a calculating service node, a storage service node, a network service node, or a cloud service control node.

The interface may receive cloud deployment amendment information, the deployment manager may determine whether to perform expansion or reduction of the cloud based on the cloud deployment amendment information, and determine a node type of a server added for expansion based on the cloud deployment amendment information and newly determine cloud components subordinate to the cloud platform type to be deployed at the added server based on the determined node type of the added server, when determining to perform expansion of the cloud based on the cloud deployment amendment information, the server manager may install and configure an operating system OS at the added server according to the determined OS type, and the deployment task executor may deploy the newly determined cloud components at the add server at which the OS has been installed and configured.

The deployment task executor may deploy the determined cloud components at the server at which the OS has been installed and configured based on a configuration file matching the determined OS type.

In accordance with one or more other embodiments, a method for automatically deploying a cloud includes receiving cloud deployment information; determining at least one of the following from the cloud deployment information: a cloud platform type, an operating system (OS) type, at least one server at which cloud to be deployed, or a node type subordinate to the cloud platform type of the at least one server based on the cloud deployment information, determining cloud components matching the node type subordinate to the cloud platform type as cloud components to be deployed at the at least one server; pushing an OS installation file and a configuration file matching the determined OS type to the at least one server, the OS installation filed and configuration filed to be installed and configured at the at least one server; and deploying the determined cloud components at the at least one server.

The method may include determining an available server, and outputting information indicative of the determined available server for selection. The method may include authenticating received authentication information, wherein the cloud deployment information is received after authentication. The method may include monitoring deployment of the cloud components, and providing an address for logging into the cloud after deployment of the cloud components. The cloud components may include at least one of a calculating service component, a storage service component, a network service component, an authentication service component, a mirror service component, or a database component. The node type of the sever may include at least one of a calculating service node, storage service node, network service node, or cloud service control node.

The method may include receiving cloud deployment amendment information, determining whether to perform expansion or reduction of the cloud based on the cloud deployment amendment information; determining a node type of a server added for expansion based on the cloud deployment amendment information and newly determines cloud components subordinate to the cloud platform type to be deployed at the added server based on the determined node type of the added server, when determining to perform expansion of the cloud based on the cloud deployment amendment information; installing and configuring an OS at the added server according to the determined OS type; and deploying the newly determined cloud components at the added server.

Deploying the determined cloud components may include deploying the determined cloud components at the server at which the OS has been installed and configured based on a configuration file matching the determined OS type.

In accordance with one or more other embodiments, an apparatus includes an interface; and a controller to receive cloud deployment information from the interface and to automatically deploy a cloud based on the deployment information, the controller to determine at least one available server, to push an operating system (OS) installation file and a matching configuration file for installation on the at least one available server to be deployed with cloud components corresponding to the cloud. The deployment information may include at least one of a cloud platform type, an OS type, the at least one server at which the cloud to be deployed, or a node type subordinate to the cloud platform type of the at least one server.

The controller may determine cloud components matching the node type subordinate to a cloud platform type as the cloud components to be deployed at at least one server. The cloud components may include at least one of calculating service component, storage service component, network service component, authentication service component, mirror service component and data base component.

### BRIEF DESCRIPTION OF THE DRAWINGS

Features will become apparent to those of skill in the art by describing in detail exemplary embodiments with reference to the attached drawings in which:

FIG. 1 illustrates an embodiment of a system for automatically deploying a cloud; and

FIG. 2 illustrates an embodiment of a method for automatically deploying a cloud.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. The embodiments may be combined to form additional embodiments.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

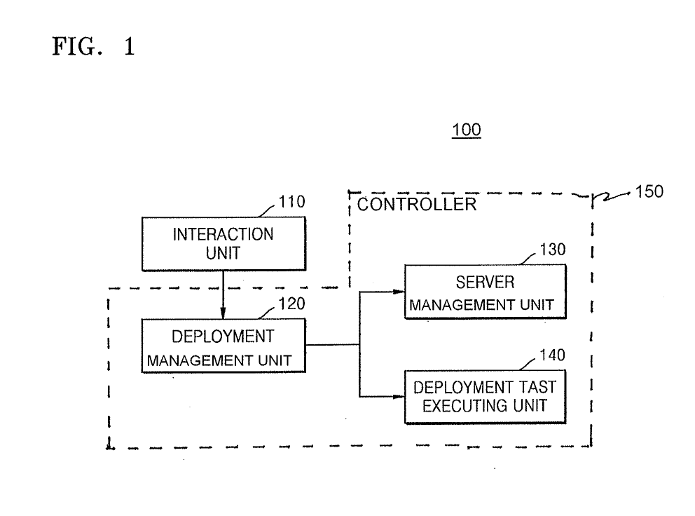

FIG. 1 illustrates an embodiment of a system 100 for automatically deploying a cloud. Referring to FIG.1, the system 100 includes an interaction unit 110, a deployment management unit 120, a server management unit 130, and a deployment task executing unit 140. At least the deployment management unit 120, the server management unit 130, and deployment management unit 140 may be considered to be a controller 150.

The interaction unit 110 receives cloud deployment information indicating various features relating to a cloud platform to be deployed. For example, the cloud deployment information may include a type of cloud platform to be deployed (e.g., OpenStack, CloudStack, Eucalyptus, etc.), a type of operating system (OS) type (e.g., Ubuntu, SUSE, Centost, etc.) of the cloud, at least one server for deploying the cloud, and/or a type of node subordinate to the cloud platform type of the server. The node type may, for example, correspond to the cloud platform type and indicate a function subordinate to a cloud platform that corresponds to the cloud platform type of the server. Examples include a calculating service node, a storage service node, a network service node, and a cloud service control node. For different cloud platform types, matching or owned node types may be different or identical. The cloud deployment information may be received from a user or a device.

When information indicative of a platform type is received, the interaction unit 110 may provide node types matching the cloud platform type for the user to select. The interaction unit 110 may provide a user interface (UI) to interact with the user, for example, in order to receive the cloud deployment information from the user.

In one embodiment, the UI is implemented by a webpage or a specific client terminal. Through the UI, the user may select a cloud platform type, an OS type, at least one server, and a node type subordinate to the cloud platform type of the server. When a certain cloud platform type is selected, node types corresponding to the cloud platform type are displayed for the user to select.

The selected servers may serve as nodes of the deployed cloud. At least the cloud service control node is deployed. The calculating service node, the storage service node, and/or the network service node may also be deployed as needed. Thus, the node type of one of the selected servers is set to be cloud service control node. The selected servers may be physical servers or virtual machines.

The cloud deployment information may also include information indicative of a cloud environment mode. Examples include a single node, a multi-node, and a high reliability environment. A single-node environment refers to implementing the cloud on a single server. In this case, one or more node types may be implemented on the single server, and all cloud components corresponding to the node types are installed at the single server. A multi-node environment refers to implementing the cloud on a plurality of servers. In this case, different node types may be implemented on different servers.

When the single-node environment is selected by the user via the interaction unit 110, the interaction unit 110 only allows the user to select one server. When the multi-node environment is selected by the user via the interaction unit 110, the interaction unit 110 allows the user to select a plurality of servers.

The high reliability environment refers to providing a backup server for a server which implements the cloud, e.g., provides a backup node. When the server that implements the cloud has a fault or otherwise malfunctions, this server may be replaced by the backup server. When the high reliability environment is selected by the user via the interaction unit 110, the interaction unit 110 may allow the user to select one or more backup servers for each one of the servers.

In one embodiment, the interaction unit 110 may allow the user to select one or more backup servers for servers which, for example, do not serve as a calculating service node and a storage service node, e.g., in one embodiment the calculating service node and storage service node are not allowed to be backed up.

The cloud deployment information may further indicate other configuration information relating to the cloud. The configuration information relating to the cloud may also be input via the UI.

In one embodiment, the system 100 may include an authentication management unit. Before receiving cloud deployment information, the interaction unit 110 may first receive authentication information of the user, e.g., login name and password. Then, the authentication management unit authenticates the user. When the user is successfully authenticated, the user may be allowed to input the cloud deployment information to deploy the cloud. In one embodiment, different levels may be set for different users and different cloud deployment authorities may be set for the different levels. For example, the higher the level, the more servers may be selected for use or the more cloud platform types or OS types may be provided to be selected, and vice versa.

The deployment management unit 120 determines the cloud platform type, the OS type, at least one server at which the cloud is to be deployed, and the node type subordinate to the cloud platform type of the server based on the cloud deployment information. The deployment management unit 120 also determines cloud components matching the node type according to the node type as the cloud components to be deployed at the server.

Since main functions of servers having different node types may be different, cloud components to be deployed may also be different. The cloud components may include, but are not limited to, a calculating service component, a storage service component, a network service component, an authentication service component, a mirror service component, and a database component. Servers with each node type may deploy one or more cloud components. For example, corresponding cloud components may be determined according to a designated node type subordinate to a designated cloud platform type. This may be accomplished through a mapping table that relates different node types subordinate to different cloud platform types and corresponding service components. It should be understood that the above cloud components are only exemplary, and cloud components of different cloud platforms may be varied.

Moreover, it should be understood that the node type and cloud components to be deployed for the above-mentioned backup server may be identical to the node type and cloud components to be deployed of the server to be deployed, e.g., the initially designed server.

The server management unit 130 installs and configures the operating system OS at the server at which cloud is to be deployed according to the determined OS type. For example, the server management unit 130 pushes an OS installation file and a configuration file matching the determined OS type to the server at which cloud is to be deployed. The OS is then installed and configured at the server. If there is a backup server, the OS installation file and the configuration file matching the determined OS type may also be pushed to the backup server, and installed and configured at the backup server. The server management unit 130 may also be used to find an available server and to provide the found available server to the user via the interaction unit 110 for selection.

The deployment task executing unit 140 deploys the determined cloud components at the server at which the OS has been installed and configured.

For a certain cloud component subordinate to a certain cloud platform type, the manner of deploying cloud components for different operating systems may be different. The deployment task executing unit 140 may deploy the determined cloud components at the server based on a configuration file matching the determined OS type. When deploying a cloud component subordinate to a cloud platform type, the configuration file matching the determined OS type may be selected from among the configuration files of the cloud component for the deploying of the cloud component. The cloud may be considered to be basically deployed (e.g., set up, configured, activated, established, initiating, and/or programmed) after the cloud components are deployed.

In addition, the deployment task executing unit 140 may install and configure one or more basic services in way of pushing prior to the deploying of cloud components. In addition, the deployment task executing unit 140 may configure cloud components deployed in way of pushing.

In one embodiment, the system 100 for automatically deploying the cloud may include a deployment monitoring unit. The deployment monitoring unit may monitor the process of deploying cloud components, and thus provide information indicative of deployment progress and results of success or fail of the deployment to the user via the interaction unit 110. The user may make decisions according to the monitoring results. For example, when the deployment fails, the cloud deployment information may be re-input and the cloud may be re-deployed. Additionally, the deployment monitoring unit may provide an address for logging into the cloud to the user after deploying of the cloud components. Thus, the deployed cloud may be used by the user according to the login address.

Cloud deployment amendment information may also be received by the interaction unit 110 for purposes of changing the cloud as currently configured. For example, the cloud deployment amendment information may correspond to expanding or reducing the cloud, changing the OS type, resetting the cloud, etc., after the cloud components are deployed.

Moreover, the system 100 for automatically deploying the cloud may include a resource providing unit to provide various resources for the server management unit 130 and/or the deployment task executing unit 140. Examples include the installation file of OS, one or more of the cloud components, the configuration file, etc.

In one embodiment, the interaction unit 110 may receive cloud deployment amendment information from the user, and the deployment management unit 120 may then determine whether to perform expansion or reduction of the cloud. When expansion of the cloud is indicated by the cloud deployment amendment information, the deployment management unit 120 determines a node type of a server added for expansion based on the cloud deployment amendment information and newly determines cloud components subordinate to the cloud platform type (e.g., determines cloud components matching the node type of the added server as cloud components) to be deployed at the added server based on the determined node type of the added server. Thereafter, the server management unit 130 installs and configures the OS at the added server according to the determined OS type, and then the deployment task executing unit 140 deploys the newly determined cloud components at the add server at which the OS has been installed. The deployment management unit 120 may delete a node corresponding to the server for reducing the cloud when the cloud deployment amendment information indicates that the cloud is to be reduced.

When the deployment management unit 120 determines to amend (e.g., change) the OS type based on the cloud deployment amendment information, the deployment management unit 120 transmits the changed OS type to the server management unit 130, and thus amends the original OS to an OS corresponding to the amended OS type. This may involve, for example, pushing an OS installation file and a configuration file matching the amended OS type to respective servers which serve as nodes, in order to install and configure the OS corresponding to the amended OS type at the servers. In addition, the deployment management unit 120 transmits the amended OS type to the deployment task executing unit 140. The deployment task executing unit 140 then re-deploys the original cloud components at the server at which the OS has been newly installed and configured. Based on the change of the OS type, the deployment task executing unit 140 re-deploys the original cloud components based on a configuration file matching the amended OS type.

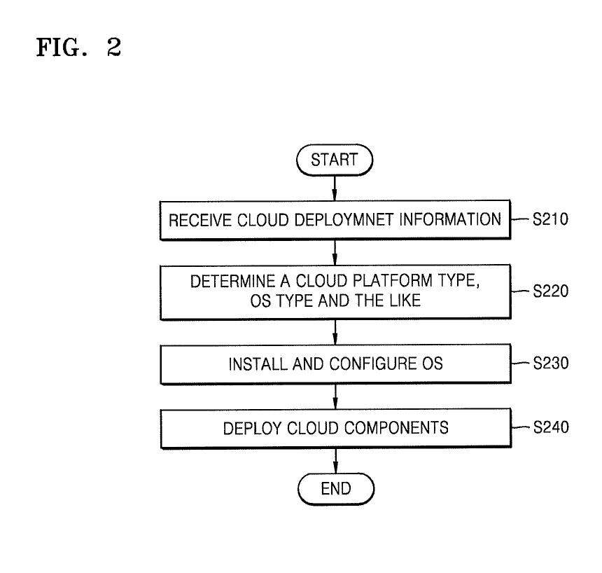

FIG. 2 illustrates an embodiment of a method for automatically deploying a cloud. The method may be executed, for example, at a deployment control server for managing the cloud deployment. In addition, in order to deploy the cloud with high reliability, a plurality of deployment control servers may be configured which includes a backup deployment control server to be used when the deployment control server has fault or otherwise has a malfunction.

Referring to FIG. 2, the method includes the interaction unit 110 receiving cloud deployment information (operation S210). The cloud deployment information may be received from a user or an external device. The cloud deployment information indicates information of the cloud to be deployed. For example, the cloud deployment information may indicate the type of cloud platform to be deployed (e.g., OpenStack, CloudStack, Eucalyptus, etc.), the operating system (OS) type (e.g., Ubuntu, SUSE, Centost, etc.), at least one server at which cloud is to be deployed, and a node type subordinate to the cloud platform type of the server (e.g., a node type corresponding to the cloud platform type and indicating a function subordinate to a cloud platform corresponding to the cloud platform type of the server). Examples include a calculating service node, a storage service node, a network service node, and a cloud service control node. For different cloud platform types, matching or owned node types may be different or identical.

When information indicative of the platform type is received, node types matching the cloud platform type are provided for the user to select. Interaction with the user may be accomplished via a user interface (UI) provided by the interaction unit 110. The cloud deployment information may be received from the user through the UI.

In one embodiment, the UI is implemented by a webpage or a specific client terminal. Through the UI, the user may select a cloud platform type, an OS type, at least one server, and a node type subordinate to the cloud platform type of the server. When a certain cloud platform type is selected, node types corresponding to the cloud platform type are displayed for the user to select.

The selected servers may serve as nodes of the cloud to be deployed. At least the cloud service control node may be deployed. The calculating service node, the storage service node, and/or the network service node may also be deployed. In other words, the node type of one of the selected servers is set to be a cloud service control node. The selected servers may be physical servers or virtual machines.

In addition, the server management unit 130 may automatically find an available server and provide information indicative of the found available server to the user for selection. Additionally, the cloud deployment information may indicate a cloud environment mode (e.g., single node, multi-node, high reliability environment, etc.) and/or other configuration information relating to deployment of the cloud. The information may be received via the UI.

When the single-node environment is selected by the user via the interaction unit 110, the interaction unit 110 only allows the user to select one server. When the multi-node environment is selected by the user via the interaction unit 110, the interaction unit 110 allows the user to select a plurality of servers. When the high reliability environment is selected by the user via the interaction unit 110, the interaction unit 110 may allow the user to select one or more backup servers for each of the servers.

In one embodiment, the interaction unit 110 allows the user to select one or more backup servers for servers different from servers which serve as a calculating service node and a storage service node. Thus, the calculating service node and the storage service node are not allowed to be backed up in at least one embodiment.

Before receiving the cloud deployment information from the user, the interaction unit 110 may first receive authentication information of the user (for example, login name and password). The authentication management unit described above may then authenticate the user based on the login name and password. When successfully authenticated, the user may be allowed to input the cloud deployment information to deploy the cloud. Different levels may be set for different users, and different cloud deployment authorities may be set for the different levels. For example, the higher the level, the more servers may be selected for use or the more cloud platform types or OS types may be provided to be selected.

The deployment management unit 120 determines the cloud platform type, the OS type, at least one server at which cloud is to be deployed, and the node type subordinate to the cloud platform type of the server based on the cloud deployment information. The deployment management unit 120 may determine cloud components matching the node type according to the node type as the cloud components deployed at the server (operation S220).

Since main functions of servers having different node types may be different, cloud components to be deployed may also be different. The cloud components may include, but are not limited to, a calculating service component, a storage service component, a network service component, an authentication service component, a mirror service component, and a database component. Servers with each node type may deploy one or more cloud components. For example, corresponding cloud components may be determined according to a designated node type subordinate to a designated cloud platform type. This may be accomplished through a mapping table relating different node types subordinate to different cloud platform types and corresponding service components.

The node type of and cloud components for the above-mentioned backup server may be identical to the node type and cloud components for the server at which the cloud is to be deployed, e.g., the initially designed server.

The server management unit 130 installs and configures OS at the server at which cloud is to be deployed according to the determined OS type (operation S230). The server management unit 130 pushes an OS installation file and a configuration file matching the determined OS type to the server at which cloud is to be deployed. The OS is then installed and configured at the server at which cloud is to be deployed.

Furthermore, if there is a backup server, the OS installation file and the configuration file matching the determined OS type may be pushed to the backup server, and the OS may be installed and configured at the backup server.

The deployment task executing unit 140 deploys the cloud components determined in operation 5210 at the server at which the OS has been installed and configured (operation S240).

For a certain cloud component subordinate to a certain cloud platform type, the manner of deploying cloud components for different operating systems OSs may be different. The deployment task executing unit 140 deploys the determined cloud components at the server based on a configuration file matching the determined OS type. When deploying a cloud component subordinate to a cloud platform type, the configuration file matching the determined OS type may be selected from among configuration files of the cloud component for the deploying the cloud components. The cloud may be considered to be basically deployed after the cloud components are deployed.

In addition, the deployment task executing unit 140 may install and configure one or more basic services in way of pushing prior to the deploying of cloud components. In addition, the deployment task executing unit 140 may configure cloud components deployed in way of pushing.

In one embodiment, the above-mentioned deployment monitoring unit may monitor the process of deploying of cloud components, and thus provide information indicative of the deployment progress and results of success or fail of the deployment to the user, for example, through the UI. The user may make decisions according to the monitoring results. For example, when the deployment fails, the cloud deployment information may be re-input and the cloud may be re-deployed. Additionally, an address for logging into the cloud may be provided to the user after the cloud components are deployed. Thus, the deployed cloud may be used by the user according to the login address.

After the cloud components are deployed, the interaction unit 110 may receive cloud deployment amendment information, for example, from the user through the UI. The deployment management unit 120 may amend (e.g., change) the current cloud, for example, by performing expansion or reduction of the cloud, amending (e.g., changing) the OS type, resetting cloud, and the like, based on the cloud deployment amendment information.

For example, the cloud deployment amendment information may indicate whether to perform expansion or reduction of the cloud. When determining to perform expansion of the cloud based on the cloud deployment amendment information, the deployment management unit 120 determines a node type of a server added for expansion based on the cloud deployment amendment information, and newly determines cloud components subordinate to the cloud platform type to be deployed at the added server based on the determined node type of the added server. Thereafter, the server management unit 130 installs and configures OS at the added server according to the determined OS type. Then, the deployment task executing unit 140 deploys the newly determined cloud components at the add server at which the OS has been installed. A node corresponding to the server for reduction may be deleted from the cloud when the cloud deployment amendment information indicates that the cloud is to be reduced.

When the cloud deployment amendment information indicates that the OS type is to be changed or otherwise amended, the server management unit 130 amends the original OS to an OS corresponding to the amended OS type and the deployment task executing unit 140 re-deploys the cloud components. For example, an OS installation file and a configuration file matching the amended OS type are pushed to respective servers. The OS corresponding to the amended OS type is then installed and configured at the servers. The original cloud components at the server at which the OS has been newly installed and configured are re-deployed by the deployment task executing unit 140. Based on the change of the OS type, the deployment task executing unit 140 re-deploys the original cloud components based on a configuration file matching the amended OS type.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing the methods described herein.

The management units, interaction units, deployment task executing units, monitoring units, and other processing and control features of the embodiments described herein may be implemented in logic which, for example, may include hardware, software, or both. When implemented at least partially in hardware, the management units, interaction units, deployment task executing units, monitoring units, and other processing and control features may be, for example, any one of a variety of integrated circuits including but not limited to an application-specific integrated circuit, a field-programmable gate array, a combination of logic gates, a system-on-chip, a microprocessor, or another type of processing or control circuit.

When implemented in at least partially in software, the management units, interaction units, deployment task executing units, monitoring units, and other processing and control features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments may transform the computer, processor, controller, or other signal processing device into a special-purpose processor for performing the methods described herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments described herein.

By way of summation and review, many types of cloud computing systems have been developed. These systems allow users to remotely access computing, storage, and network resources, thereby alleviating the need to purchase the physical resources themselves. Examples of cloud infrastructure providing platforms include OpenStack, CloudStack, and Eucalyptus. However, it is difficult to flexibly build a personal or private cloud computing platform. It is also difficult to create a personal data center using existing cloud computing platforms without being restricted by various features of the platforms and their operating systems.

In accordance with one or more of the aforementioned embodiments, a system and method is provided for automatically deploying a cloud. As a result, a user may deploy a cloud with less input and without specialized knowledge of a user. In one embodiment, a one-click automatic deploying of a cloud for naked servers (e.g., physical servers or virtual machines) may be achieved. In addition, the system and method may be compatible with various operating systems and cloud platforms and may allow for the cloud to be extended or otherwise changed, for example, through a convenient user interface.

Furthermore, the embodiments for automatically deploying cloud may be implemented by a computer program for performing the operations described above. In addition, respective units of the system may be implemented in hardware components. The respective units may be implemented as Field Programmable Gate Array (FPGA), application specific integrated circuit (ASIC), or specific servers.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the embodiments as set forth in the following claims.

What is claimed is:

1. A system for automatically deploying a cloud, comprising:
an interface to receive cloud deployment information;
a deployment manager to receive the cloud deployment information from the interface, the deployment information including a cloud platform type, an operating system (OS) type, at least one server at which cloud to be deployed, and a node type subordinate to the cloud platform type of the at least one server, the deployment manager to determine cloud components matching the node type subordinate to the cloud platform type as cloud components to be deployed at the at least one server;
a server manager to pushes an OS installation file and a configuration file matching the OS type for installation at least one server; and
a deployment task executor to deploy the determined cloud components at the at least one server.

2. The system as claimed in claim 1, wherein, the server manager is to determine an available server and to output information indicative of the available server via the interface for selection.

3. The system as claimed in claim 1, further comprising:
an authentication manager to authenticate authentication information received through the interface, wherein the interface is to receive the cloud deployment information after the authentication information is authenticated.

4. The system as claimed in claim 1, further comprising:
a deployment monitor to monitor deployment of the cloud components by the deployment task executor and provides an address for logging the cloud to a user after the deploying of the cloud components.

5. The system as claimed in claim 1, wherein, the cloud components includes at least one of calculating service component, storage service component, network service component, authentication service component, mirror service component, and database component.

6. The system as claimed in claim 1, wherein the node type of the server includes at least one of a calculating service node, a storage service node, a network service node, or a cloud service control node.

7. The system as claimed in claim 1, wherein:
the interface is to receive cloud deployment amendment information,
the deployment manager is to determine whether to perform expansion or reduction of the cloud based on the cloud deployment amendment information, and to determine a node type of a server added for expansion based on the cloud deployment amendment information and newly determine cloud components subordinate to the cloud platform type to be deployed at the added server based on the determined node type of the added server, when determining to perform expansion of the cloud based on the cloud deployment amendment information,
the server manager is to install and configure an operating system OS at the added server according to the determined OS type, and
the deployment task executor is to deploy the newly determined cloud components at the add server at which the OS has been installed and configured.

8. The system as claimed in claim 1, wherein the deployment task executor is to deploy the determined cloud components at the server at which the OS has been installed and configured based on a configuration file matching the OS type.

9. A method for automatically deploying a cloud, the method comprising:
receiving cloud deployment information;
determining a cloud platform type, an operating system (OS) type, at least one server at which cloud to be deployed, and a node type subordinate to the cloud platform type of the at least one server based on the cloud deployment information,
determining cloud components matching the node type subordinate to the cloud platform type as cloud components to be deployed at the at least one server;
pushing an OS installation file and a configuration file matching the OS type to the at least one server, the OS installation filed and configuration filed to be installed and configured at the at least one server; and
deploying the cloud components at the at least one server.

10. The method as claimed in claim 9, further comprising:
determining an available server, and
outputting information indicative of the determined available server for selection.

11. The method as claimed in claim 9, further comprising:
authenticating received authentication information,
wherein the cloud deployment information is received after authentication.

12. The method as claimed in claim 9, further comprising:
monitoring deployment of the cloud components, and
providing an address for logging into the cloud after deployment of the cloud components.

13. The method as claimed in claim 9, wherein the cloud components include at least one of a calculating service component, a storage service component, a network service component, an authentication service component, a mirror service component, or a database component.

14. The method as claimed in claim 9, wherein the node type of the at least one sever includes at least one of a calculating service node, a storage service node, a network service node, or cloud service control node.

15. The method as claimed in claim 9, further comprising:
receiving cloud deployment amendment information,
determining whether to perform expansion or reduction of the cloud based on the cloud deployment amendment information;
determining a node type of a server added for expansion based on the cloud deployment amendment information and newly determines cloud components subordinate to the cloud platform type to be deployed at the added server based on the determined node type of the added server, when determining to perform expansion of the cloud based on the cloud deployment amendment information;
installing and configuring an operating system OS at the added server according to the determined OS type; and
deploying the newly determined cloud components at the added server.

16. The method as claimed in claim 9, wherein deploying the cloud components includes deploying the cloud components at the server at which the OS has been installed and configured based on a configuration file matching the OS type.

17. An apparatus, comprising:
an interface; and
a controller to receive cloud deployment information from the interface and to automatically deploy a cloud based on the deployment information, the controller to determine at least one available server, to push an operating system (OS) installation file and a matching configuration file for installation on the at least one available server to be deployed with cloud components corresponding to the cloud.

18. The apparatus as claimed in claim 17, wherein the deployment information includes at least one of a cloud platform type, an OS type, the at least one server at which the cloud to be deployed, or a node type subordinate to the cloud platform type of the at least one server.

19. The apparatus as claimed in claim 18, wherein the controller is to determine cloud components matching the node type subordinate to a cloud platform type as the cloud components to be deployed at at least one server.

20. The apparatus as claimed in claim 17, wherein the cloud components include at least one of calculating service component, storage service component, network service component, authentication service component, mirror service component, and data base component.
